(19) United States
(12) Patent Application Publication
(10) Pub. No.: US 2010/0062655 A1
(43) Pub. Date: Mar. 11, 2010

(54) MULTIPART PLUG-TYPE CONTACT HOUSING

(76) Inventors: Werner DENGLER, Nueziders (AT); Manfred Maehr, Roethis (AT)

Correspondence Address: K.F. ROSS P.C., 5683 RIVERDALE AVENUE, SUITE 203 BOX 900, BRONX, NY, 10471-0900, US

(21) Appl. No.: 12/494,584

(22) Filed: Jun. 30, 2009

(30) Foreign Application Priority Data
Jun. 30, 2008 (DE) 102008030296.1

(51) Int. Cl. H01R 24/00

(52) U.S. Cl. 439/661

(57) ABSTRACT

The invention concerns a multi-part plug-type connector housing in hybrid design with contacts that can be fitted with various and separate contacts and terminals for transmitting signals, particularly from lead frames to contact pins that are preferably combined into contact groups, whereby in accordance with the invention the plug-type connector housing has a hybrid plug element with fixed contacts (2) in a housing module (1) and a plug element with fixed contacts (2a) in a housing part (3) and that the housing part (3) can be connected with housing module (1).

The invention concerns a multipart plug-type contact-assembly housing for a plug-type contact assembly in hybrid construction that can be fitted with various and separate contacts and terminals for transmitting signals, particularly from lead frames to contact pins that are preferably combined in contact groups according to the characteristics of the introductory clause of claim 1.

Hybrid plug-type connectors are known for such purposes that can be fitted with various and separate contacts and terminals for transmitting signals from, for example, lead frames to contact pins, as well as with separate wiring for the contacts. When the hybrid plug-type connector establishes contact with the corresponding coupling element, all the contacts are connected with each other by a single hybrid plug-type connector.

The invention therefore has the object of providing a cost-effective possibility of combining electric or electronic functions from various modules into one contact assembly, while however providing a variable design of the various modules.

This problem is solved by the features of claim 1.

In accordance with the invention the plug-type connector housing is provided with a hybrid plug element with fixed contacts in a housing module and a plug element with fixed contacts in a housing part, and that the housing module can be connected with the housing part. As a result of this design, the housing module can be separated from the housing part, so that both construction components can subsequently be fitted out as desired without affecting the other construction element.

Advantageously, the housing part can be inserted in a cavity of the housing module. This way, the contacts of the plug component can be slid through the openings of the housing module. But it is also possible that the cavity is a throughgoing opening in the housing module so that the housing module only guides the housing part.

The housing part and the housing module can be mounted on each other, which can take place, for example, via latches or the like. But they can also be screwed together. Even a gasket between the housing part and the housing module can be provided. The contacts of the housing part preferably are arrayed the same as the contacts in the housing module, preferably numbering more than 1. But the contacts of the housing part can also have a different configuration compared to that in the housing module. The hybrid plug element is preferably designed as plug collar in the housing module.

The proposed hybrid plug-type connectors are preferably built in modules with various requirements for making contact, for example, with a module for the transmission of high voltage and with a component for transmission of signals with low signal voltages.

In total, in an advantageous manner, fewer contacts, an increased safeguard against failure, lead frames with simple shape, a modular design, and galvanization of the contacts as needed as well as cost effective manufacturing is achieved.

In a further embodiment of the invention, reference is made to the drawings, in which an example of an embodiment of the invention is shown in simplified form. Therein:

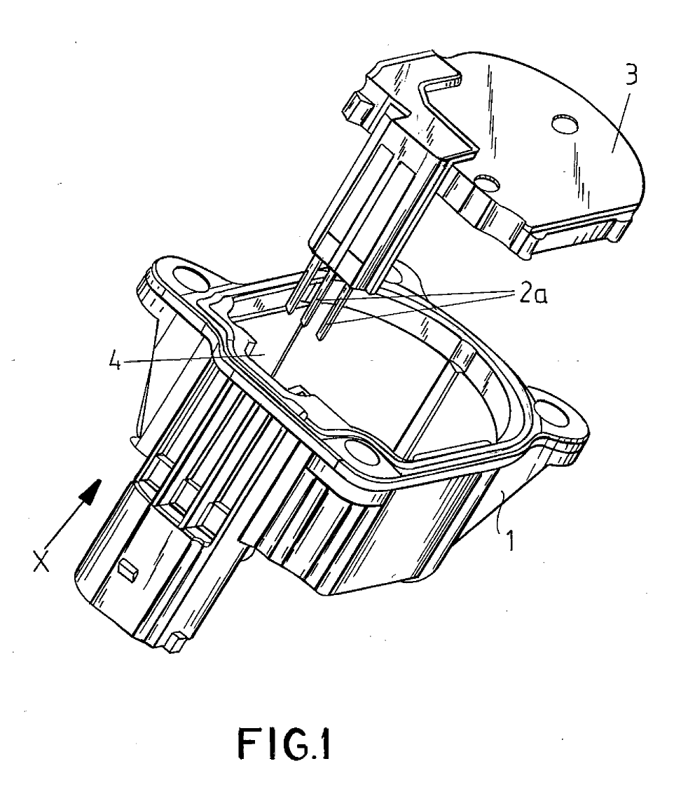

FIG. 1 is an exploded view of a plug-type contact assembly housing.

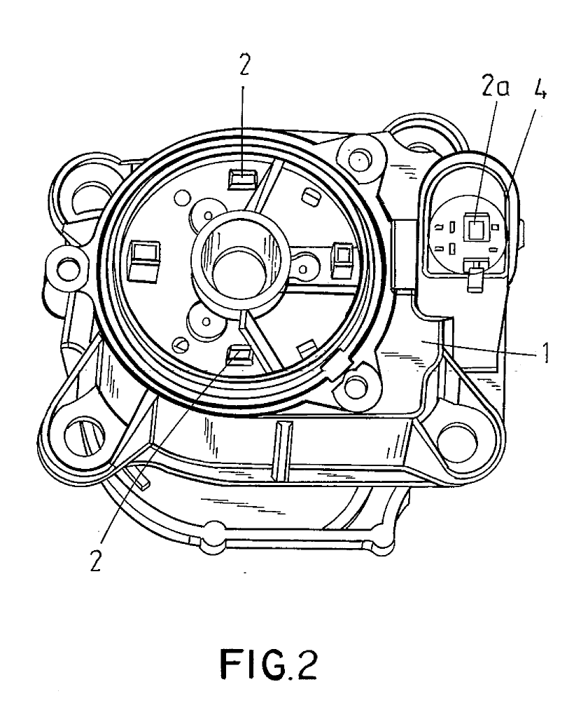

FIG. 2 is a view taken in the direction of arrow X of FIG. 1.

A housing module shown at 1 has several contacts 2. A housing part shown at 3 can be inserted into an opening 4 of the housing module 1. The housing part 3 also has contacts 2a.

As a result of inserting the housing part into the housing module, the complete plug-type connector for establishing contact with the components in both parts is formed.

### LEGEND

1. housing module
2. 2a contacts
3. housing part
4. opening

1. A multipart plug-type contact-assembly housing in hybrid construction that can be fitted with various or separate contacts and terminals for the transmission of signals, particularly from lead frames to contact pins, and that are preferably combined in contact groups wherein the plug-type contact-assembly housing has a hybrid plug element with fixed contacts in a housing module and a plug element with fixed contacts in a housing part and that the housing part can be connected with housing module.

2. The multipart plug-type contact-assembly housing according to claim 1 wherein the housing part can be inserted into a cavity of the housing module.

3. The multipart plug-type contact-assembly housing according to claim 1 wherein the cavity is designed as a throughgoing opening in housing module.

4. The multipart plug-type contact-assembly housing according to claim 1 wherein the housing part and the housing module can be mounted on each other.

5. The multipart plug-type contact-assembly housing according to claim 1 wherein the contacts of the housing part have the same configuration with a number greater than 1 like the contacts in the housing module with a number larger than 1.

6. The multipart plug-type contact-assembly housing according to claim 1 wherein the contacts of the housing part are arrayed differently from the contacts in housing module.

7. The multipart plug-type contact-assembly housing according to claim 1 wherein the hybrid plug element is preferably designed as plug collar in housing module.
